(19) United States
(12) Patent Application Publication
(10) Pub. No.: US 2002/0053004 A1
(43) Pub. Date: May 2, 2002

(54) ASYNCHRONOUS CACHE COHERENCE ARCHITECTURE IN A SHARED MEMORY MULTIPROCESSOR WITH POINT-TO-POINT LINKS

(76) Inventor: FONG PONG, MOUNTAIN VIEW, CA (US)

Correspondence Address: IP ADMINISTRATION, LEGAL DEPARTMENT 20BN, HEWLETT PACKARD COMPANY, P O BOX 10301, PALO ALTO, CA, 943030890

(21) Appl. No.: 09/444,173

(22) Filed: Nov. 19, 1999

(51) Int. Cl. G06F 12/08

(52) U.S. Cl. 711/119; 711/146; 711/144; 711/147

(57) ABSTRACT

In a shared memory, multiprocessor system, an asynchronous cache coherence method associates state information with each data block to indicate whether a copy of the data block is valid or invalid. When a processor in the multiprocessor system requests a data block, it issues the request to one or more other processors and the shared memory. Depending on the implementation, the request may be broadcast, or specifically targeted to processors having a copy of the requested data block. Each of the processors and memory that receive the request independently check to determine whether they have a valid copy of the requested data block based on the state information. Only the processor or memory having a valid copy of the requested data block responds to the request. The memory control path between each processor and a shared memory controller may be implemented with two unidirectional and dedicated point-to-point links for sending and receiving requests for blocks of data.

### TECHNICAL FIELD

The invention relates to shared memory, multiprocessor systems, and in particular, cache coherence protocols.

### BACKGROUND

A shared memory multiprocessor system is a type of computer system having two or more processors, each sharing the memory system and capable of executing its own program. These systems are referred to as “shared memory” because the processors can each access the system's memory. There are a variety of different types of memory models, such as Uniform Memory Access (UMA), Non Uniform Memory Access (NUMA) and Cache Only Memory Architecture (COMA) model.

Both single and multiprocessors typically use caches to reduce the time required to access data in memory (the memory latency). A cache improves access time because it enables a processor to keep frequently used instructions or data nearby, where it can access them more quickly than from memory. Despite this benefit, cache schemes create a different challenge called the cache coherence problem. The cache coherence problem refers to the situation where different versions of the same data can have different values. For example, a newly revised copy of the data in the cache may be different than the old, stale copy in the memory. This problem is more complicated in multiprocessors where each processor typically has its own cache.

The protocols used to maintain coherence for multiple processors are called cache-coherence protocols. The objective of these protocols is to track the state of any sharing of a data block. One type of protocol is called “snooping.” In this type of protocol, every cache that has a copy of the data from a block of physical memory also has a copy of the sharing status of the block. The caches are typically on a shared-memory bus, and all cache controllers monitor or “snoop” on the bus to determine whether or not they have a copy of a block that is requested on the bus.

One example of a traditional snooping protocol is the P6/P7 bus architecture from Intel Corporation. In Intel's scheme, when a processor issues a memory access request and has a miss in its local cache, the request (address and command) is broadcast on the control bus. Subsequently, all other processors and the memory controller listening to the bus will latch in the request. The processors then each probe their local caches to see if they have the data. Also, the memory controller starts a “speculative” memory access. The memory access is termed “speculative” because it proceeds without knowing whether the data copy from the memory request will be used.

After a fixed number of cycles, all processors report their snoop results by asserting a HIT or HITM signal. The HIT signal means that the processor has a clean copy of the data in its local cache. The HITM signal means that the processor has an exclusive and modified copy of the data in its local cache. If a processor cannot report its snoop result in time, it will assert both the HIT and HITM signals. This results in insertions of the wait state until the processor completes its snoop activity.

Generally speaking, the snoop results serve two purposes: 1) they provide sharing information; and 2) they identify which entity should provide the missed data block, i.e. either one of the processors or the memory. In processing a read miss, a processor may load the missed block in the exclusive or shared state depending on whether the HIT or HITM signal is asserted. For example, in the case where another processor has the most recently modified copy of the requested data in a modified state, it asserts the HITM signal. Consequently, it prevents the memory from responding with the data.

Anytime a processor asserts the HITM signal, it must provide the data copy to the requesting processor. Importantly, the speculative memory access must be aborted. If no processor asserts the HITM signal, the memory controller will provide the data.

The traditional snooping scheme outlined above has limitations in that it 30 requires all processors to synchronize their response. The design may synchronize the response by requiring all processors to generate their snoop results in exactly the same cycle. This requirement imposes a fixed latency time constraint between receiving bus requests and producing the snoop results.

The fixed latency constraint presents a number of challenges for the design of processors with multiple-level cache hierarchies. In order to satisfy the fixed latency constraint, the processor may require a special purpose, ultra fast snooping logic path. The processor may have to adopt a priority scheme in which it assigns a higher priority to snoop requests than requests from the processor's execution unit. If the processor cannot be made fast enough, the fixed time between snoop request and snoop report may be increased. Some combination of these approaches may be necessary to implement synchronized snooping.

The traditional snooping scheme may not save memory bandwidth. In order to reduce memory access latency, the scheme fetches the memory copy of the requested data in parallel with the processor cache look up operations. As a result, unnecessary accesses to memory occur. Even if a processor asserts a HITM signal indicating that it will provide the requested data, the speculative access to memory still occurs, but the memory does not return its copy.

### SUMMARY

The invention provides an asynchronous cache coherence method and a multiprocessor system that employs an asynchronous cache coherence protocol. One particular implementation uses point-to-point links to communicate memory requests between the processors and memory in a shared memory, multiprocessor system.

In the asynchronous cache coherence method, state information associated with each data block indicates whether a copy of the data block is valid or invalid. When a processor in the multiprocessor system requests a data block, it issues the request to one or more other processors and the shared memory. Depending on the implementation, the request may be broadcast, or specifically targeted to processors having a copy of the requested data block. Each of the processors and memory that receive the request independently check to determine whether they have a valid copy of the requested data block based on the state information. Only the processor or memory having a valid copy of the requested data block responds to the request.

A multiprocessor that employs the asynchronous cache coherence protocol has two or more processors that communicate with a shared memory via a memory controller. Each of the processors and shared memory are capable of storing a copy of a data block, and each data block is associated with state indicating whether the copy is valid. The processors communicate a request for a data block to the memory controller. The other processors and shared memory process the request by checking whether they have a valid copy of the data block. The processor or shared memory having the valid copy of the requested data block responds, and the other processors drop the request silently.

One implementation utilizes point-to-point links in the memory control path to send and receive requests for blocks of data. In particular, each processor communicates with the memory controller via two dedicated, and unidirectional links. One link issues requests for data blocks, while the other receives requests. Similar point-to-point links may be used to communicate blocks of data between processors and the memory controller.

Further features and advantages of the invention will become apparent with reference to the following detailed description and accompanying drawings.

### BRIEF DESCRIPTION OF THE DRAWINGS

FIG. 1 is a block diagram illustrating a shared memory multiprocessor that employs an asynchronous cache protocol.

FIG. 2 is a block diagram illustrating an example of a multiprocessor that implements a memory control path with point-to-point links between processors and the memory controller.

FIG. 3 is a block diagram illustrating an example of a data path implementation for the multiprocessor shown in FIG. 2.

FIG. 4 is a block diagram of a multiprocessor with a memory controller that uses an internal cache for buffering frequently accessed data blocks.

FIG. 5 is a block diagram of a multiprocessor with a memory controller that uses an external cache for buffering frequently accessed data blocks. FIG. 6 illustrates a data block that incorporates a directory identifying which processors have a copy of the block.

### DESCRIPTION

Introduction

For the sake of this discussion, the code and data in a multiprocessor system are generally called “data.” The system organizes this data into blocks. Each of these blocks is associated with state information (sometimes referred to as “state”) that indicates whether the block is valid or invalid. This state may be implemented using a single bit per memory block. Initially, blocks in memory are in the valid state. When one of the processors in the multiprocessor system modifies a block of data from memory, the system changes the state of the copy in memory to the invalid state.

This approach avoids the need for processors to report snoop results. Each processor processes requests for a block of data independently. In particular, each processor propagates a read or write request through its cache hierarchy independently. When a processor probes its local cache and discovers that it does not have a data block requested by another processor, it simply drops the request without responding. Conversely, if the processor has the requested block, it proceeds to provide it to the requesting processor. This scheme is sometimes referred to as “asynchronous” because the processors do not have to synchronize a response to a request for a data block.

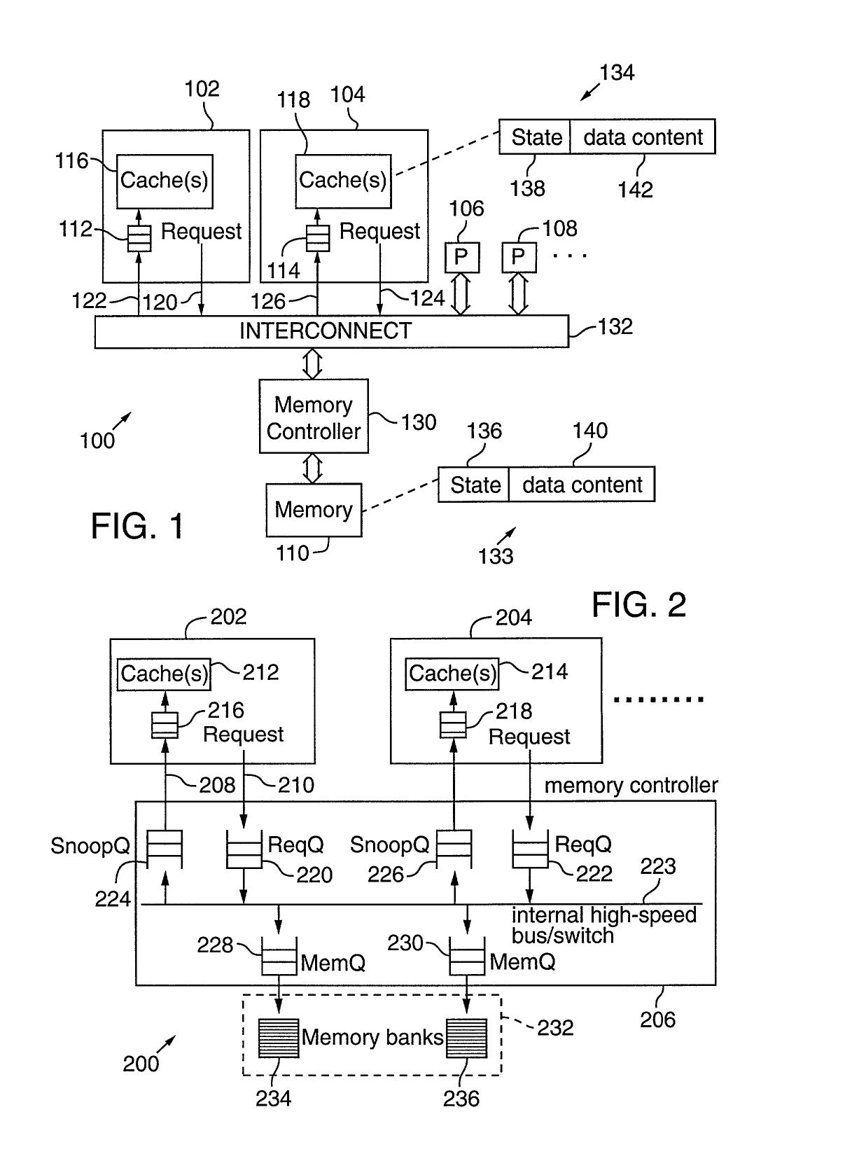

FIG. 1 illustrates an example of a shared memory system 100 that employs this approach. The system has a number of processors 102-108 that each accesses a shared memory 1 10. Two of the processors 102, 104 are expanded slightly to reveal an internal FIFO buffer (e.g., 112, 114), a cache system (e.g., 116, 118) and control paths (e.g., 120-126) for sending and receiving memory access requests. For example, a processor 102 in this architecture has a control path 120 for issuing a request, and a control path 1 22 for receiving requests. FIG. 1 does not illustrate a specific example of the cache hierarchy because it is not critical to the design.

Each of the processors communicate with each other and a memory controller 130 via an interconnect 132. FIG. 1 depicts the interconnect 132 generally because it may be implemented in a variety of ways, including, but not limited to, a shared bus or switch. In this model, the main memory 110 is treated like a cache. At any given time, one or more processors may have a copy of a data block from memory in its cache. When a processor modifies a copy of the block, the other copies in main memory and other caches become invalid. The state information associated with each block reflects its status as either valid or invalid.

FIG. 1 shows two examples of data blocks 133, 134 and their associated state information (see, e.g., state information labeled with reference nos. 136 and 138). In the two examples, the state information is appended to the data block. Each block has at least one bit for state information and the remainder of the block is data content 140, 142. Although the state information is shown appended to the copy of the block, it is possible to keep the state information separately from the block as long as it is associated with the block.

Point-to-point Links In the Memory Control Path

While the interconnect illustrated in FIG. 1 can be implemented using a conventional bus design based on shared wires, such a design has limited scalability. The electrical loading of devices on the bus, in particular, limit the speed of the bus clock as well as the number of devices that can be attached to the bus. A better approach is to use high speed point-to-point links as the physical medium interconnecting processors with the memory controller. The topology of a point-to-point architecture may be made transparent to the devices utilizing it by emulating a shared bus type of protocol.

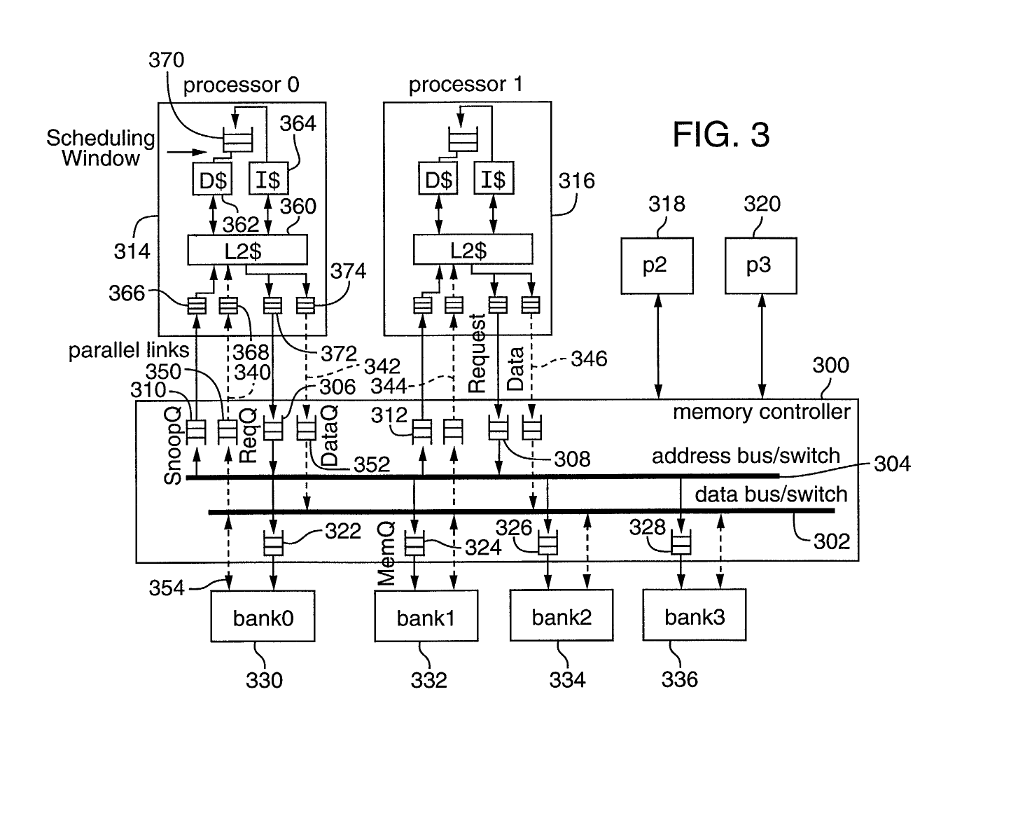

FIG. 2 is a block diagram of a shared memory multiprocessor 200 that employs point-to-point links for the memory control path. In the design shown in FIG. 2, the processors 202, 204 and memory controller 206 communicate through two dedicated and unidirectional links (e.g., links 208 and 210 for processor 202).

Like FIG. 1, FIG. 2 simplifies the internal details of the processors because they are not particularly pertinent to the memory system. The processors include one or more caches (e.g., 212-214), and a FIFO queue for buffering incoming requests for data (e.g., 216, 218).

When a processor issues a request for a block of data, the request first enters a request queue (ReqQ, 220, 222) in the memory controller 206. The memory controller has one request queue per processor. The queues may be designed to broadcast the request to all other processors and the memory, or alternatively may target the request to a specific processor or set of processors known to have a copy of the requested block. In the latter case, the system has additional support for keeping track of which processors have a data block as explained further below.

Preferably, the request queues communicate requests via a high-speed internal address bus or switch 223 (referred to generally as a “bus” or “control path interconnect”). Each of the processors and memory main memory devices are capable of storing a copy of a requested data block. Therefore, each has a corresponding destination buffer (e.g., queues 224, 226, 228, 230) in the memory controller for receiving memory requests from the bus 223. The buffers for receiving requests destined for processors are referred to as snoop queues (e.g., SnoopQs 224 and 226).

The main memory 232 may be comprised of a number of discrete memory devices, such as the memory banks 234, 236 shown in FIG. 2. These devices may be implemented in conventional DRAM, SDRAM, RAMBUS DRAM, etc. The buffers for receiving requests destined for these memory devices are referred to as memory queues (e.g., memoryQs 228, 230).

The snoopQs and memoryQs process memory requests independently in a First In, First Out manner. Unless specified otherwise, each of the queues and buffers in the multiprocessor system process requests and data in a First In, First Out manner. The snoopQs process requests one by one and issue them to the corresponding processor. For example, the snoopQ labeled 224 in FIG. 2 sends requests to the processor labeled 202, which then buffers the requests in its internal buffer 21 6, and ultimately checks its cache hierarchy for a valid copy of the requested block.

Just as a request is queued in the snoopQs, it is also queued in the memoryQ, which initiates the memory accesses to the appropriate memory banks.

The point-to-point links in the memory control path have a number of advantages over a conventional bus design based on shared wires. First, a relatively complex bus protocol required for a shared bus is reduced to a simple point-to-point protocol. As long as the destination buffers have space, a request can be pumped into the link every cycle. Second, the point-to-point links can be clocked at a higher frequency (e.g., 400 MHz) than the traditional system bus (e.g., 66 MHz to 100 MHz). Third, more processors can be attached to a single memory controller, provided that the memory bandwidth is not a bottleneck. The point-to-point links allow more processors to be connected to the memory controller because they are narrow links (i.e. have fewer wires) than a full-width bus.

The Data Path

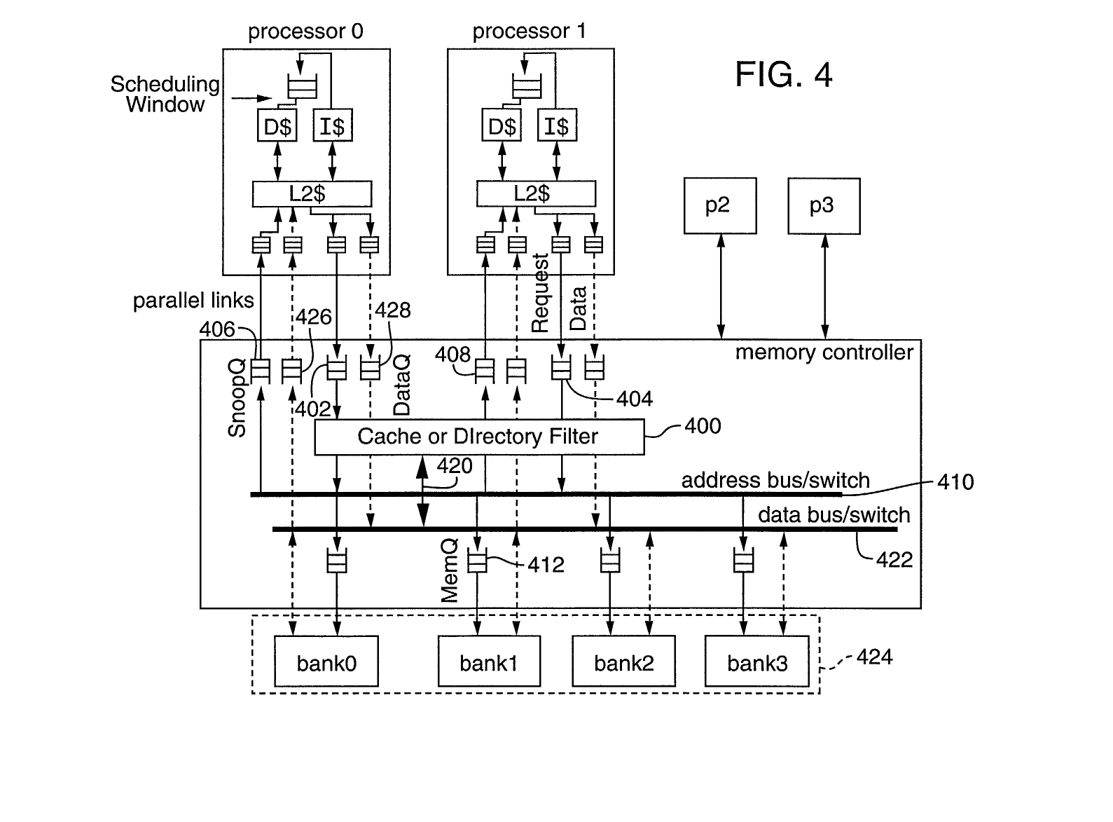

The system illustrated in FIG. 2 only shows the memory control path. The path for transferring data blocks between memory and each of the processors is referred to as the data path. The data path may be implemented with data switches, point-to-point links, a shared bus, etc. FIG. 3 illustrates one possible implementation of the data path for the architecture shown in FIG. 2.

In FIG. 3, the memory controller 300 is expanded to show a data path implemented with a data bus or switch 302. The control path is implemented using an address bus or switch 304 as described above. In response to the request queues (e.g., 306, 308), the control path communicates requests to the snoop queues (e.g., 310, 312) for the processors 314-320 and to the memory queues (e.g., 322-328) for the memory banks 330-336.

In this design, each of the processors has two dedicated and unidirectional point-to-point links 340-346 with the memory controller 300 for transferring data blocks. The data blocks transferred along these links are buffered at each end. For example, a data block coming from the data bus 302 and destined for a processor is buffered in an incoming queue 350 corresponding to that processor in the memory controller. Conversely, a data block coming from the processor and destined for the data bus is buffered in an outgoing queue 352 corresponding to that processor in the memory controller. The data bus, in turn, has a series of high speed data links (e.g., 354) with each of the memory banks (330-336).

Two of the processors 314, 316 are expanded to reveal an example of a cache hierarchy. For example, the cache hierarchy in processor 0 has a level two cache, and separate data and instruction caches 362, 364. This diagram depicts only one possible example of a possible cache hierarchy. The processor receives control and data in memory control and data buffers 366, 368, respectively. The level two cache includes control logic to process requests for data blocks from the memory control buffer 366. In addition, it has a data path for receiving data blocks from the data buffer 368. The level two cache partitions code and data into the instruction and data caches, respectively. The execution unit 370 within the processor fetches and executes instructions from the instruction cache and controls transfers of data between the data cache and its internal register files.

When the processor needs to access a data block and does not have it in its cache, the level two cache issues a request for the block to its internal request queue 372, which in turn, sends the request to a corresponding request queue 306 in the memory controller. When the processor is responding to a request for a data block, the level two cache transfers the data block to an internal data queue 374. This data queue, in turn, processes data blocks in FIFO order, and transfers it to the corresponding data queue 352 in the memory controller.

Further Optimizations

The performance of the control path may be improved by keeping track of which processors have copies of a data block and limiting traffic in the control path by specifically addressing other processors or memory rather than broadcasting commands.

Directory Based Filter for Read Misses

Since data blocks are associated with additional state information, this state information can be extended to include the ID of the processor that currently has a particular data block. This ID can be used to target a processor when a requesting processor makes a read request and finds that its cache does not have a valid copy of the requested data block. Using the processor ID associated with the requested data block, the requesting processor specifically addresses the read request to the processor that has the valid copy. All other processors are shielded from receiving the request.

While this approach improves the performance of memory accesses on read requests, it does not address the issue of cache coherence for write requests. Shared memory multiprocessors typically implement a cache coherence protocol to make sure that the processors access the correct copy of a data block after it is modified. There are two primary protocols for cache coherence: write invalidation and write update. The write invalidation protocol invalidates other copies of a data block in response to a write operation. The write update (sometimes referred to as write broadcast) protocol updates all of the cached copies of a data block when it is modified in a write operation.

In the specific approach outlined above for using the processor ID to address a processor on a read request, the multiprocessor system may implement a write update or write invalidation protocol. In the case of a write invalidation protocol, the memory controller broadcasts write invalidations to all processors, or uses a directory to reduce traffic in the control path as explained in the next section.

Directory Based Filter for All Traffic

To further reduce traffic in the control path, the memory controller can use a directory to track the processors that have a copy of a particular data block. A directory, in this context, is a mechanism for identifying which processors have a copy of a data block. One way to implement the directory is with a presence bit vector. Each processor has a bit in the presence bit vector for a data block. When the bit corresponding to a processor is set in the bit vector, the processor has a copy of the data block.

In a write invalidation protocol, the memory controller can utilize the directory to determine which processors have a copy of data block, and then multi-cast a write invalidation only to the processors that have a copy of the data block. The directory acts as a filter in that it reduces the number of processors that are targeted for a write invalidation request.

Implementation of the Memory Directory

There are a variety of ways to implement a memory directory. Some possible examples are discussed below.

Separate Memory Depository

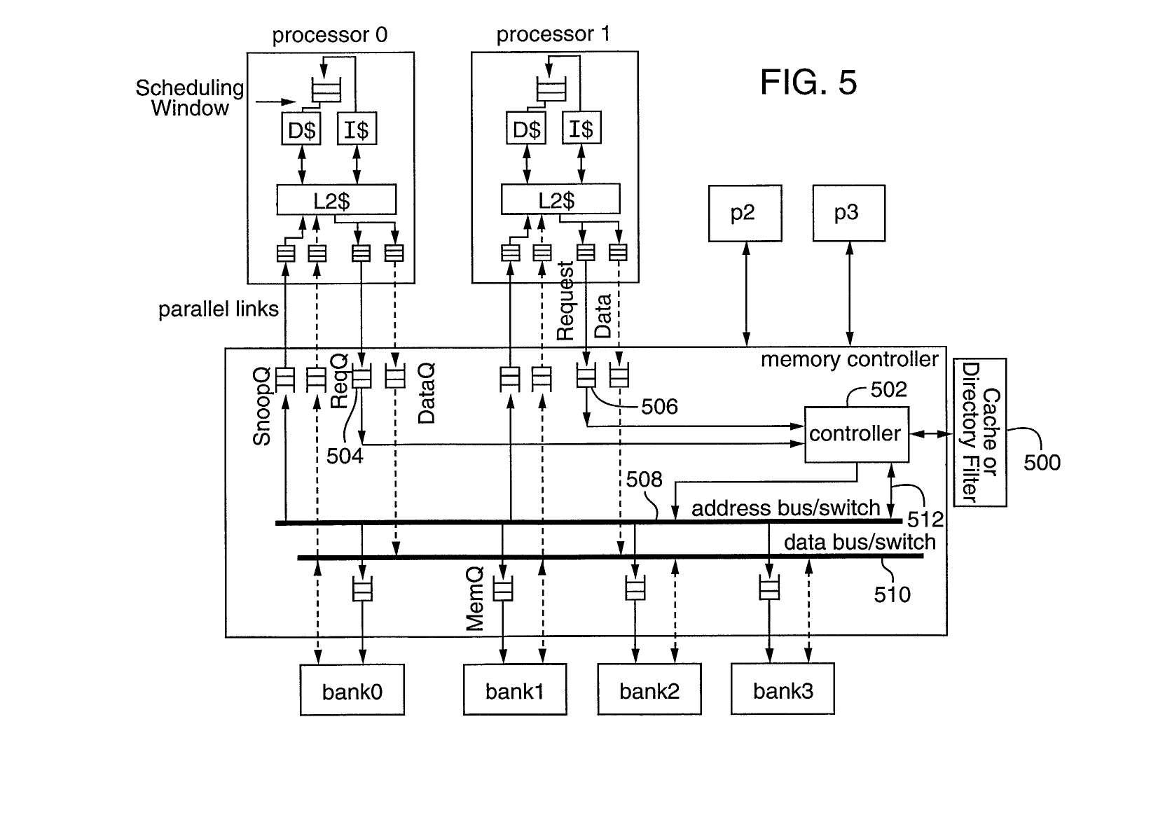

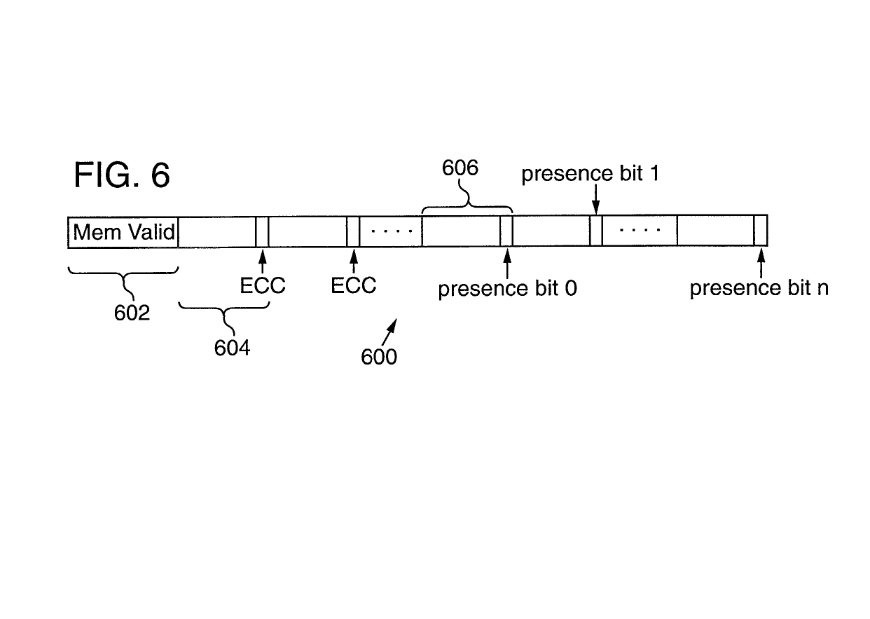

One way to implement the memory directory is to use a separate memory bank for the directory information. In this implementation, the memory controller directs a request from the request queue to the directory, which filters the request and addresses it to the appropriate processors (and possibly memory devices). FIGS. 4 and 5 show alternative implementations of the multiprocessor system depicted in FIG. 2. Since these Figures contain similar components as those depicted in FIGS. 2 and 3, only components of interest to the following discussion are labeled with reference numbers. Unless otherwise noted, the description of the components is the same as provided above.

As shown in these figures, the directory may be stored in a memory device that is either integrated into the memory controller or implemented in a separate component. In FIG. 4, the directory is stored on a memory device 400 integrated into the memory controller. The directory filter 400 receives requests from the request queues (e.g., 402, 404) in the memory controller, determines which processors have a copy of the data block of interest, and forwards the request to the snoopQ(s) (e.g., 406, 408) corresponding to these processors via the address bus 410. In addition, the directory filter forwards the request to the memoryQ (e.g., 412) of the memory device that stores the requested data block via the address bus 410.

In FIG. 5, the directory is stored on separate memory component 500. The operation of the directory filter is similar to the one shown in FIG. 4, except that a controller 502 is used to interconnect the request queues 504, 506 and the address bus 508 with the directory filter 500.

Folding the Directory into Data Blocks

Rather than using a component to maintain the directory, it may be incorporated into the data blocks. For example, the directory may be incorporated into the Error Correction Code bits of the block. Memory is typically addressed in units of bytes. A byte is an 8 bit quantity. In addition to the 8 bits of data within a byte, each byte is usually associated with an additional ECC bit. In the case where a data block is comprised of 64 bytes, there are 64 ECC bits. In practice, nine bits of ECC are used to protect 128 bits of data. Thus, only 36 ECC bits are necessary to protect a block of 64 bytes. The remaining 28 ECC bits may be used to store the directory.

FIG. 6 illustrates an example of a data block that incorporates a presence bit vector in selected ECC bits of the block. The block is associated with state information 602, such as a bit indicating whether the block is valid or invalid, and the processor ID of a processor currently having a valid copy of the block. The data content section of the block is shown as a contiguous series of bytes (e.g., 604 . . . 606), each having an ECC bit. Some of these bits serve as part of the block's error correction code, while others are bits in the presence bit vector. Each bit in the presence bit vector corresponds to a processor in the system and indicates whether that processor has a copy of the block.

Reducing Latency and Demand for Memory Bandwidth

The directory scheme does not solve the problem of memory bandwidth. Due to the directory information, a request to access a block may potentially require two memory accesses: one access for the data, and another for updating the directory.

A further optimization to reduce accesses to memory is to buffer frequently accessed blocks in a shared cache as shown in FIGS. 4 and 5. The use of a cache reduces accesses to memory because many of the requests can be satisfied by accessing the memory controller's cache instead of the main memory. The blocks 400, 500 in FIGS. 4 and 5 that illustrate the directory filter also illustrate a possible implementation of a cache.

FIG. 4 illustrates a cache 400 that is integrated into the memory controller. The cache is a fraction of the size of main memory and stores the most frequently used data blocks. The memory controller issues requests to the cache directly from the request queues 402, 404. When the requested block is in the cache, the cache provides it to the requesting processor via the data bus and the data queue of the requesting processor. When a block is requested that is not in the cache, the cache replaces an infrequently used block in the cache with the requested block. The cache uses a link 420 between it and the data bus 422 to transfer data blocks to and from memory 424 and to and from the data queues (e.g., 426, 428) corresponding to the processors.

FIG. 5 illustrates a cache that is implemented in a separate component from the memory controller. The operation of the cache is similar to the cache in FIG. 4, except that the controller 502 is responsible for receiving requests from the request queues 504, 506 and forwarding them to the cache 500. In addition, the cache communicates with data queues and memory on the data bus 510 via a link 512 between the controller and the data bus.

Conclusion

While the invention is described with reference to specific implementations, the scope of the invention is not limited to these implementations. There are a variety of ways to implement the invention. For example, the examples provided above show point-to-point links in the control and data path between the processors and memory. However, it possible to implement a similar asynchronous cache coherence scheme without using point-to-point control or data links. It is possible to use a shared bus instead of independent point-to-point links.

The discussion above refers to two types of cache coherence protocols: write invalidate and write update. Either of these protocols may be used to implement the invention. Also, while the above discussion refers to a snooping protocol in some cases, it may also employ aspects of a directory protocol.

In view of the many possible implementations of the invention, it should be recognized that the implementations described above are only examples of the invention and should not be taken as a limitation on the scope of the invention. Rather, the scope of the invention is defined by the following claims. I therefore claim as my invention all that comes within the scope and spirit of these claims.

I claim:

1. A method for accessing memory in a multiprocessor system, the method comprising:
from a requesting processor, issuing a request for a block of data to one or more other processors and memory, each copy of the block of data being associated with state information indicating whether the copy is valid or invalid;
in each of the processors and memory that receive the request, checking to determine whether a valid copy of the block of data exists; and
returning a valid copy of the requested data from one of the other processors or memory such that only the processor or memory having the valid copy of the data block responds to the request.

2. The method of claim 1 in which:
each of the processors communicates with the memory via a memory controller and each of the processors has a point-to-point link with the memory controller for issuing a request for a block of data to the memory controller.

3. The method of claim 2 in which:
each point-to-point link includes two dedicated and unidirectional links.

4. The method of claim 2 in which the point-to-point links are control links for sending and receiving requests for blocks of data.

5. The method of claim 2 in which each of the processors has a control path point-to-point link for sending and receiving requests for blocks of data, and a data path point-to-point link for sending and receiving blocks of data .

6. The method of claim 1 in which the processors and shared memory that have an invalid copy of the requested block of data drop the request without responding.

7. The method of claim 1 including:
tracking an identification of a processor that currently has a data block; and
in response to a cache miss in a requesting processor, using the identification to specifically target a read request to the processor that currently has the requested data block.

8. The method of claim 1 including:
maintaining a directory indicating the one or more processors that have a copy of a block of data;
when the block of data is modified, using the directory to issue a write invalidation or write update only to the processors that have the copy of the block of data.

9. A multiprocessor system comprising:
two or more processors, each in communication with a shared memory via a memory controller;
the processors in communication with the memory controller for issuing a request for a block of data, each of the processors and the shared memory being capable of storing a copy of the requested block of data, and each copy of the requested block of data being associated with state indicating whether the copy is valid or invalid,
each of the processors and the shared memory being responsive to a request to check itself for a valid copy of a requested block such that only the processor or shared memory having the valid copy responds to the request for the requested block.

10. The system of claim 9 in which:
each of the processors communicates with the memory via a memory controller and each of the processors has a point-to-point link with the memory controller for issuing a request for a block of data to the memory controller.

11. The system of claim 10 in which:
each point-to-point link includes two dedicated and unidirectional links.

12. The system of claim 10 in which the point-to-point links are control links for sending and receiving requests for blocks of data.

13. The system of claim 10 in which each of the processors has a control path point-to-point link for sending and receiving requests for blocks of data, and a data path point-to-point link for sending and receiving blocks of data.

14. The system of claim 9 including:
a directory indicating which processors have a copy of a data block;
wherein the processors are in communication with the directory to identify which other processors have a copy of the data block, and directing requests for the data block only to processors that have a copy of the data block.

15. The system of claim 14 wherein the directory is incorporated into the data block.

16. The system of claim 14 wherein the directory is stored in a separate memory that filters a request and forwards the request only to a processor or processors that have a copy of the data block.

17. The system of claim 14 wherein the memory controller is in communication with a shared cache, separate from caches of the processors, for buffering most frequently accessed data blocks.

18. The system of claim 9 wherein each block has state information indicating which processor currently has a valid copy of a data block, and wherein the processors utilize the state information to specially address a processor having the valid copy in response to a cache miss in a requesting processor.

19. A multiprocessor system comprising:
two or more processors, each in communication with a shared memory;
the processors in communication with the shared memory for issuing a request for a block of data, each of the processors and the shared memory being capable of storing a copy of the requested block of data, and each copy of the requested block of data being associated with state indicating whether the copy is valid or invalid,
each of the processors and the shared memory being responsive to a request to check itself for a valid copy of a requested block such that only the processor or shared memory having the valid copy responds to the request for the requested block.

20. The system of claim 19 wherein each of the processors and the shared memory is in communication with a control path interconnect, and each of the processors is in communication with the control path interconnect via a point-to-point link for receiving and sending requests for blocks of data;
each of the processors having a corresponding request queue connecting the point-to-point link of the processor to the control path interconnect, and each of the processors having a corresponding snoop queue connecting the point-to-point link of the processor to the control path interconnect;
the request queue in communication with a corresponding processor for buffering requests for blocks of data by the processor and issuing the requests to other processors via the control path interconnect; and
the snoop queue in communication with a corresponding processor for buffering requests for blocks of data destined for the processor.
